(19) United States
(12) Patent Application Publication
(10) Pub. No.: US 2007/0034440 A1
(43) Pub. Date: Feb. 15, 2007

(54) Method and device for preventing unintended acceleration of a vehicle

(75) Inventor: Zoltan Zomotor, Stuttgart (DE)

Correspondence Address: FITCH, EVEN, TABIN & FLANNERY, P. O. BOX 18415, WASHINGTON, DC, 20036, US

(73) Assignee: DaimlerChrysler AG, Stuttgart (DE)

(21) Appl. No.: 10/573,599

(22) PCT Filed: Sep. 2, 2004
(86) PCT No.: PCT/EP04/09755

§ 371 Date: May 15, 2006

(30) Foreign Application Priority Data
Sep. 26, 2003 (DE) 103 44 705.9

(51) Int. Cl. B60T 7/22

(52) U.S. Cl. 180/275

(57) ABSTRACT

The invention relates to a method and a device for preventing unintended acceleration of a vehicle. In the method according to the invention, a first actuation variable which describes actuation (V_{FB}) of a driving operating element which is provided for influencing drive means of the vehicle is determined, the vehicle remaining unaccelerated if an idling condition which is dependent on the first actuation variable which is determined is fulfilled. In addition to the first actuation variable, a second actuation variable which describes actuation (V_{BB}) of a brake operating element which is provided for influencing braking means of the vehicle is determined, the idling condition also being dependent on the second actuation variable which is determined.

The invention relates to a method and a device for preventing unintended acceleration of a vehicle. For this purpose, a first actuation variable which describes actuation of a driving operating element which is provided for influencing drive means of the vehicle is determined, the vehicle remaining unaccelerated if an idling condition which is dependent on the first actuation variable which is determined is fulfilled.

Such a device for an accelerator pedal of a vehicle is disclosed in the document JP 08-253054. In order to avoid traffic accidents owing to incorrect actuation of the accelerator pedal which is provided for accelerating the vehicle, instead of actuation of a brake pedal which is provided for braking the vehicle, the device has an accelerator pedal sensor which interacts with the accelerator pedal and senses an accelerator pedal speed which is caused by the driver and converts it into a corresponding sensor signal which is fed to a control unit for evaluation. If the control unit determines, inter alia, that an accelerator pedal speed is present which is atypical of customary actuation of the accelerator pedal and which permits incorrect actuation of the accelerator pedal to be inferred, drive means which are provided for accelerating the vehicle are placed in an idling state which is neutral in terms of acceleration. The known device is primarily designed for sensing incorrect actuation of the accelerator pedal, but inadvertent slipping of the driver's foot from the brake pedal to the accelerator pedal is not readily detected.

The object of the present invention is therefore to develop a method and a device of the type mentioned at the beginning in such a way that reliable detection of inadvertent slipping of the driver's foot or the driver's hand from a brake operating element which is provided for braking the vehicle to a driving operating element which is provided for accelerating the vehicle is made possible.

This object is achieved according to the features of patent claim 1 and of patent claim 11, respectively.

In the method according to the invention for preventing unintended acceleration of a vehicle, a first actuation variable which describes actuation of a driving operating element which is provided for influencing drive means of the vehicle is determined, the vehicle remaining unaccelerated if an idling condition which is dependent on the first actuation variable which is determined is fulfilled. In addition to the first actuation variable, a second actuation variable which describes actuation of a brake operating element which is provided for influencing braking means of the vehicle is determined, the idling condition also being dependent on the second actuation variable which is determined. By evaluating the actuation variables both of the driving operating element and of the brake operating element it is possible to reliably detect inadvertent slipping of the driver's foot or of the driver's hand from the brake operating element onto the driving operating element. One application of the method according to the invention is appropriate in particular in vehicles which are equipped with an automatic transmission. Since these vehicles do not have a clutch between the engine and the transmission which could be opened when a braking process is carried out, the slipping from the brake operating element onto the driving operating element inevitably leads here to uncontrolled acceleration of the vehicle which can lead to accidents depending on the traffic situation and the situation in the surroundings.

Advantageous embodiments of the method according to the invention emerge from the subclaims.

Advantageously, the first actuation variable describes an actuation speed of the driving operating element, and/or the second actuation variable describes an actuation speed of the brake operating element. Evaluating the actuation speeds permits particularly reliable detection of slipping from the brake operating element onto the driving operating element.

Additionally or alternatively it is possible to determine a dead time variable which describes the time between the end of actuation of the brake operating element and the start of subsequent actuation of the driving operating element, the idling condition also being dependent on the dead time variable which is determined. Since inadvertent slipping of the driver's foot or of the driver's hand from the brake operating element onto the driving operating element leads to characteristic values for the dead time variable, the slipping can be sensed with an extremely high degree of reliability by evaluating the dead time variable.

The idling condition is fulfilled in particular if by evaluating the actuation variables it is determined that the actuation speed of the brake operating element exceeds an actuation threshold value which is predefined for the brake operating element when the actuation is ended, and that the actuation speed of the driving operating element exceeds a second actuation threshold value which is predefined for the driving operating element when the actuation is resumed. In this context, ending the actuation of the brake operating element is intended, in the customary way, to cause the braking of the vehicle to be reduced, and resuming the actuation of the driving operating element is intended to cause the vehicle to accelerate. Since the actuation speeds when inadvertent slipping occurs from the brake operating element onto the driving operating element assume relatively large values compared to a customary change of actuation, the slipping can be easily and precisely differentiated from the usual change of actuation by predefining correspondingly large actuation threshold values.

The idling condition is fulfilled if by evaluating the dead time variable it is also determined that the time described by the dead time variable drops below a predefined time threshold value. Since the time described by the dead time variable assumes relatively small values in the case of slipping from the brake operating element onto the driving operating element compared to a usual change of actuation, the slipping from the brake operating element onto the driving operating element can be differentiated in a particularly precise way from the usual change of actuation by predefining a correspondingly low time threshold value. The time threshold value, like the first and second actuation threshold values, can be determined on the basis of driving trials or the like.

So that the vehicle remains unaccelerated only in cases in which the inadvertent slipping from the brake operating element onto the driving operating element would predictably lead to serious accidents, it is advantageous if the idling condition is additionally dependent on at least one driving state variable which describes the driving state of the vehicle. In this way it is possible to reduce automatic interventions into the drive means of the vehicle to what is absolutely necessary.

Inadvertent slipping from the brake operating element onto the driving operating element can lead to rear-end collisions with an obstacle located in the direction of travel of the vehicle especially when parking or maneuvering the vehicle or when traveling in a traffic jam. All these driving states have in common a low, if not negligible, velocity of the vehicle. A first driving state variable which describes the velocity of the vehicle is correspondingly determined, the idling condition being fulfilled if by evaluating the first driving state variable it is also determined that the velocity drops below a predefined velocity threshold value. The velocity threshold value is predefined in such a way that it is characteristic of the stationary state or of a crawling state of the vehicle.

A short distance from an obstacle located in the direction of travel of the vehicle can, in the case of inadvertent slipping from the brake operating element onto the driving operating element, also lead to a rear-end collision with the obstacle. For this reason, a second driving state variable which describes the distance between the vehicle and the obstacle is determined, the idling condition being fulfilled if by evaluating the second driving state variable it is also determined that the distance drops below a predefined distance threshold value. The distance threshold value is typically in the range of a few meters.

In this context, it is possible for the distance threshold value to be determined as a function of the velocity of the vehicle or the relative velocity between the vehicle and obstacle. This is preferably done in such a way that the distance threshold value is increased in order to adapt it to the actually existing risk of a rear-end collision as the velocity or relative velocity increases.

In order to be able to detect that the distance between the vehicle and obstacle is decreasing over time and thus that there is a potentially increasing risk of a rear-end collision, a third driving state variable which describes the relative velocity between the vehicle and the obstacle located in the direction of travel of the vehicle is determined. In this context it will be assumed that a positive relative velocity corresponds to a distance between the vehicle and the obstacle which increases over time, and a negative relative velocity corresponds to a distance between the vehicle and the obstacle which decreases over time. The idling condition is correspondingly fulfilled if by evaluating the third driving state variable it is also determined that the relative velocity drops below a predefined relative velocity threshold value which is preferably predefined as essentially zero.

The method and device according to the invention will be explained below in more detail with reference to the appended drawings, in which:

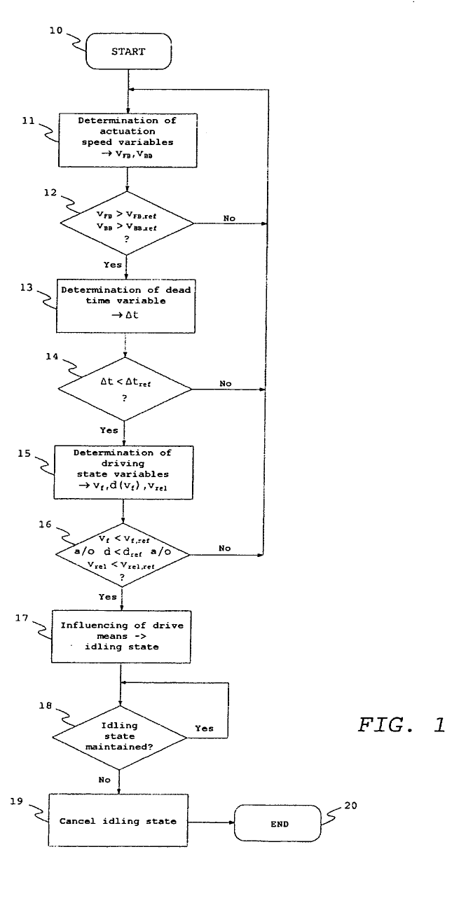

FIG. 1 shows an exemplary embodiment of the method according to the invention in the form of a flowchart, and

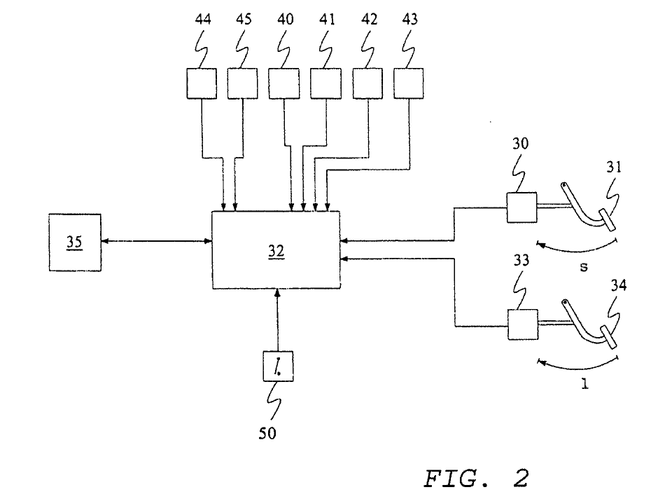

FIG. 2 is a schematically illustrated exemplary embodiment of the device according to the invention.

FIG. 1 shows an exemplary embodiment of the method according to the invention for preventing unintended acceleration of a vehicle. The method is started in an initialization step 10 after which a first actuation variable and a second actuation variable are determined in a first main step 11. In this context, the first actuation variable describes an actuation speed V_{FB} of a driving operating element which is provided for influencing drive means of the vehicle, and the second actuation variable describes an actuation speed V_{BB} of a brake operating element which is provided for influencing braking means of the vehicle.

If, by evaluating the actuation variables, it is determined in a second main step 12 that, when the actuation is ended, the actuation speed V_{BB} of the brake operating element exceeds an actuation threshold value v_{BB,ref} which is predefined for the brake operating element, and that when the actuation is resumed the actuation speed V_{FB} of the driving operating element exceeds an actuation threshold value v_{FB,ref} which is predefined for the driving operating element, the system continues with a third main step 13. Otherwise, the method sequence returns to the first main step 11 in order to begin from the start.

In the third main step 13, a dead time variable which describes the time Δt between the end of actuation of the brake operating element and the start of subsequent actuation of the driving operating element is determined, the third main step 13 being followed by a fourth main step 14 in which, by evaluating the dead time variable, it is determined whether the time Δt which is described by the dead time variable drops below a predefined time threshold value Δt_{ref}. If this is the case, the system continues with a fifth main step 15, and otherwise the method sequence returns again to the first main step 11.

In the fifth main step 15, a first driving state variable which describes the velocity v_{f} of the vehicle and/or a second driving state variable which describes the distance d between the vehicle and an obstacle located in the direction of travel of the vehicle, and/or a third driving state variable which describes the relative velocity vᵣₑₗ between the vehicle and the obstacle, are determined.

After this, in a sixth main step 16, by evaluating the first driving state variable and/or the second driving state variable and/or the third driving state variable it is determined whether the velocity v_{f} of the vehicle drops below a predefined velocity threshold value v_{f,ref}, and/or whether the distance d between the vehicle and the obstacle drops below a predefined distance threshold value d_{ref}, and/or whether the relative velocity vᵣₑₗ between the vehicle and the obstacle drops below a predefined relative velocity threshold value v_{f,rel}.

If this is the case, in a seventh main step 17 the drive means of the vehicle are influenced in such a way that despite the actuation of the driving operating element the vehicle remains unaccelerated (idling state). According to the example, the distance variable is determined as a function of the velocity v_{f} of the vehicle, and instead of the velocity v_{f} it is also possible for the relative velocity vᵣₑₗ to be between the vehicle and the obstacle.

The main steps 12, 14 and 16 therefore form an idling condition, the vehicle remaining unaccelerated when said condition applies. The conditions which are specified in the sixth main step 16 do not necessarily need to be logically combined with one another by the AND/OR logic operation which is specified by way of example, but instead any other logic operations which are generally known from combinatorics (for example NOR, NOT or ExOR) are also conceivable.

The idling state is maintained in an eighth main step 18 until it is determined that a predefined termination condition is fulfilled. If the latter is the case, the idling state is cancelled in a ninth main step 19 and the method is ended in a subsequent closing step 20.

The termination condition is fulfilled, for example, if by evaluating the distance variable and/or the relative velocity variable it is determined that the distance d exceeds a predefined safety distance dₛ and/or the relative velocity vᵣₑₗ exceeds a predefined (positive) safety relative velocity v_{rel,s}. The safety distance ds characterizes here a low, if not entirely negligible, risk of a rear-end collision, while the safety relative velocity v_{rel,s} describes a risk of a rear-end collision which tends to decrease. In particular, the following applies
dₛ≧d_{ref} or v_{rel,s}≧v_{rel,ref},
where
v_{rel,s}≧0.

FIG. 2 shows a schematically illustrated exemplary embodiment of the device according to the invention for carrying out the method according to the invention.

The device has first determining means 30 which are provided for determining the first actuation variable, the first actuation variable describing the actuation speed V_{FB} of the driving operating element 31. The first determining means 30 are, for example, a driving operating element sensor which registers a driving operating element deflection s which is caused by the driver at the driving operating element 31, and converts it into a corresponding sensor signal which is fed to an evaluation unit 32.

In addition to the first determining means 30 there are second determining means 33 which are provided for determining the second actuation variable, the second actuation variable describing the actuation speed V_{BB} of the brake operating element 34. The second determining means 33 are a brake operating element sensor which registers a brake operating element deflection 1 which is caused by the driver at the brake operating element 34 and converts it into a corresponding sensor signal which is also fed to the evaluation unit 32.

If the evaluation unit 32 determines that the idling condition which is dependent on the first and second actuation variables is fulfilled, the drive means 35 of the vehicle are influenced in such a way that the vehicle remains unaccelerated despite the actuation of the driving operating element 31.

The actuation variables are determined, for example, by deriving over time or forming gradients for the sensed driving operating element deflection s or the sensed brake operating element deflection 1, either in the determining means 30, 33 themselves or else in the evaluation unit 32 by evaluating the signals of the determining means 30, 33.

For example, the driving operating element 31 or the brake operating element 34 is embodied in the form of an accelerator pedal or brake pedal which is arranged in the vehicle, it being alternatively possible to provide a control stick (side stick). Such a control stick is described, for example, in the document DE 196 25 496 C2.

In addition to the two actuation variables, the dead time variable is also included in the idling condition. The dead time variable is determined in the evaluation unit 32 on the basis of the signals which are made available by the determining means 30, 33.

In order to determine the first driving state variable which describes the velocity v_{f}, the evaluation unit 32 evaluates the signals of wheel speed sensors 40 to 43 which sense the wheel speeds of the wheels of the vehicle. Furthermore, sensor means 44, 45 are provided in order to determine the second driving state variable which describes the distance d between the vehicle and the obstacle and the third driving state variable which describes the relative velocity vᵣₑₗ between the vehicle and the obstacle. The sensor means 44, 45 are, for example, radar sensors or ultrasonic sound sensors such as are used in common distance control systems or parking aids. The second driving state variable is determined, like the third driving state variable, either in the sensor means 44, 45 themselves or else in the evaluation unit 32 by evaluating the signals which are made available by the sensor means 44, 45. As well as in the front region, the sensor means 44, 45 can additionally also be arranged in the rear region of the vehicle so that obstacles located both in the forward direction of travel and in the reverse direction of travel of the vehicle can be sensed, it being possible to detect the respective direction of travel by evaluating the shifted position of a gear lever which is arranged in the vehicle and is provided for changing the gear speed of the vehicle.

The device according to the invention is activated and deactivated by means of a switch 50 which is arranged in the vehicle.

1. A method for preventing unintended acceleration of a vehicle, in which a first actuation variable which describes actuation (V_{FB}) of a driving operating element (31) which is provided for influencing drive means (35) of the vehicle is determined, and in which the vehicle remains unaccelerated if an idling condition which is dependent on the first actuation variable which is determined is fulfilled, characterized in that, in addition to the first actuation variable, a second actuation variable which describes actuation (V_{BB}) of a brake operating element (34) which is provided for influencing braking means of the vehicle is determined, the idling condition also being dependent on the second actuation variable which is determined.

2. The method as claimed in claim 1, characterized in that the first actuation variable describes an actuation speed (V_{FB}) of the driving operating element (31), and/or in that the second actuation variable describes an actuation speed (V_{BB}) of the brake operating element (34).

3. The method as claimed in claim 1, characterized in that a dead time variable which describes the time (Δt) between the end of actuation of the brake operating element (34) and the start of subsequent actuation of the driving operating element (31) is determined, the idling condition also being dependent on the dead time variable which is determined.

4. The method as claimed in claim 2, characterized in that the idling condition is fulfilled if by evaluating the first and second actuation variables it is determined that the actuation speed (V_{BB}) of the brake operating element (34) exceeds a first actuation threshold value (v_{BB,ref}) which is predefined for the brake operating element (34), and in that the actuation speed (V_{FB}) of the driving operating element (31) exceeds a second actuation threshold value (V_{FB,ref}) which is predefined for the driving operating element (31).

5. The method as claimed in claim 4, characterized in that a dead time variable which describes the time (Δt) between the end of actuation of the brake operating element (34) and the start of subsequent actuation of the driving operating element (31) is determined, the idling condition also being dependent on the dead time variable which is determined; and the idling condition is fulfilled if by evaluating the dead time variable it is also determined that the time (Δt) described by the dead time variable drops below a predefined time threshold value (Δt_{ref}).

6. The method as claimed in claim 1, characterized in that the idling condition is dependent on at least one driving state variable which describes the driving state of the vehicle.

7. The method as claimed in claim 6, characterized in that a first driving state variable which describes the velocity (v_{f}) of the vehicle is determined, the idling condition being fulfilled if by evaluating the first velocity variable it is also determined that the velocity (v_{f}) drops below than a predefined velocity threshold value (v_{f,ref}).

8. The method as claimed in claim 7, characterized in that a second driving state variable which describes the distance (d) between the vehicle and an obstacle which is located in the direction of travel of the vehicle is determined, the idling condition being fulfilled if by evaluating the second driving state variable it is also determined that the distance (d) drops below a predefined distance threshold value (d_{ref}).

9. The method as claimed in claim 8, characterized in that the distance threshold value (d_{ref}) is determined as a function of the velocity (v_{f}) of the vehicle or the relative velocity (v_{ref}) between the vehicle and the obstacle.

10. The method as claimed in claim 6, characterized in that a third driving state variable which describes the relative velocity (v_{ref}) between the vehicle and an obstacle located in the direction of travel of the vehicle is determined, the idling condition being fulfilled if by evaluating the third driving state variable it is also determined that the relative velocity (vᵣₑₗ) drops below a predefined relative velocity threshold value (v_{rel,ref}).

11. A device for preventing unintended acceleration of a vehicle, having first determining means (30) which determine a first actuation variable which describes actuation (v_{FB}) of a driving operating element (31) which is provided for influencing drive means (35) of the vehicle, and having an evaluation unit (32) which determines whether an idling condition which is dependent on the first actuation variable which is determined is fulfilled, and, when the idling condition is fulfilled, said evaluation unit (32) influences the drive means (35) in such a way that the vehicle remains unaccelerated, characterized in that, in addition to the first determining means (30), second determining means (33) are provided which determine a second actuation variable which describes actuation (v_{BB}) of a brake operating element (34) which is provided for influencing braking means of the vehicle, the idling condition also being dependent on the second actuation variable which is determined.
